(19) United States
(12) Patent Application Publication
(10) Pub. No.: US 2023/0415117 A1
(43) Pub. Date: Dec. 28, 2023

(54) PLASMA GAS REACTOR

(71) Applicant: MATERIA NOVA ASBL, Mons (BE)

(72) Inventors: Fabrizio MASERI, Mons (BE); Thomas GODFROID, Mons (BE)

(21) Appl. No.: 18/247,835

(22) PCT Filed: Oct. 8, 2021
(86) PCT No.: PCT/EP2021/077877

§ 371 Date: Apr. 4, 2023

(30) Foreign Application Priority Data
Oct. 9, 2020 (BE) BE2020/5703

(51) Int. Cl. B01J 19/08; C01B 3/24; H05H 1/24; H05H 1/34; H05H 1/30

(52) U.S. Cl. CPC B01J 19/08; C01B 3/24; H05H 1/2406; H05H 1/34; H05H 1/30; C01B 2203/0861; B01J 2219/0898; B01J 2219/0869; C01B 2203/1241; B01J 2219/00322

(57) ABSTRACT

The current invention relates to a plasma reactor comprising: a reactor space, an axial gas inlet suitable for fluid flow in an axial direction, said axial inlet comprising radial injection slits for discharging a jet of gaseous mixture into said reactor space, a downstream gas expansion disc, which extends radially from the coaxial inlet and is located downstream of said radial injection slits with respect to said axial direction, plasma generating means suitable for ionizing a gaseous medium within said reactor space, and a cylindrical reactor container, coaxial with said gas inlet, encompassing said reactor space, said reactor container comprising outlet means. The invention further relates to a multistage reactor. The invention also relates to the use of said plasma reactor.

### FIELD OF THE INVENTION

The present invention relates to a reactor suitable for chemical reactions as well as creating a plasma within at least a part of the reactor. In particular the reactor is suitable for gaseous reactants at a high pressure.

### BACKGROUND

There are a number of methods and also systems for decomposition of hydrocarbons into a carbon part and hydrogen. The traditional production methods for hydrogen from hydrocarbons in an industrial process relate to steam reforming of hydrocarbons. Often air or oxygen is added to the steam-hydrocarbon mixture in a deficit. The methods are inefficient since substantial parts of the hydrocarbons which were to be converted were used as energy sources for the process, thus obtaining a low utilization factor. In addition the yield was further reduced due to the fact that the combustion process was not complete, thus causing carbon monoxide and carbon dioxide to be produced, as well as nitrogen oxides in the presence of nitrogen. These waste gases from the processes will not be able to be used for any other purpose than as a fuel gas, with the consequent release of polluting environmental gases. Additionally, separating hydrogen gas and gaseous byproducts may be difficult and an additional cost.

Conventional thermal pyrolysis of natural hydrocarbons is a thermally-activated equilibrium reaction at temperatures ranging from 1200 to 2000 K. This method exhibits limited energy and conversion performances. Some use a catalyst to operate at lower temperature (˜1000 K) still with limited yields and leading to other problems such as catalyst deactivation due to carbon deposition. Regeneration of such de-activated catalyst is energy consuming and often produces large amount of CO2.

With regard to the utilization factor of the hydrocarbon feedstock, plasma pyrolysis has proved to be much more effective and a number of experiments have been performed with the utilization of plasma torches. As mentioned in the introduction, however, this has not resulted in any continuous, industrial production due to low thermal efficiency, low methane inlet pressures required to obtain a stable plasma, low hydrogen outlet pressures requiring several stages of compressors and a high amount of energy to store and transport hydrogen in an industrially applicable manner.

EP 0 675 925 describes a method and a device for pyrolytic decomposition of hydrocarbons into a carbon part and hydrogen. An issue with this device is the use of a standard reaction vessel. During operation, large sections of this reaction vessel do not reach conditions suitable for either decomposition or reaction. Consequently the efficiency of the reactor is quite low. Additionally, the reactor operates at pressures too low to be applicable at a large, industrial scale.

US2003/0024806 describes a plasma whirl reactor. However, this plasma whirl reactor is designed for municipal waste as carbon source rather than gaseous hydrocarbons. Additionally, the reactor has a small reactive plasma zone within the reactor space. Consequently, a large segment of reactor is not utilized to the fullest extent. The thermal and plasma reaction efficiency are low.

The present invention aims to resolve at least some of the problems and disadvantages mentioned above. The aim of the invention is to provide a method which eliminates those disadvantages. The present invention targets at solving at least one of the aforementioned disadvantages.

### SUMMARY OF THE INVENTION

The present invention and embodiments thereof serve to provide a solution to one or more of above-mentioned disadvantages. To this end, the present invention relates to a plasma reactor according to claim 1.

The reactor design aims to improve:
the overlay of powerful plasma and reactive gas to obtain both high power density and good plasma/gas overlay,
improved utilization of thermal plasma, allowing the use of concentrated sources which generally are associated with high radiative losses and large fatal energy as well as expensive material costs due to the very high temperatures,
allow utilization of high pressure (industrial) gas, such as 20 bar and above within a plasma reactor system. GLIDARC designs can operate at pressures up to a maximum of 10 bar; thermal plasma torches generally operate at or below atmospheric pressure,
allow the usage of cheaper materials by avoiding thermal and chemical effects on the reactor vessel,
allow safe and secure operation despite high temperatures, highly reactive plasma and ionic species and possibly high voltages depending on plasma generation means,
allow simple upscaling from a single-stage reactor to multiple stage reactors to easily increase the reactor throughput without requiring redesign.

Preferred embodiments of the device are shown in any of the claims 2 to 11.

A specific preferred embodiment relates to an invention according to claim 3. Such plasma reactors have a large overlap between plasma and reactive gas. Additionally, the reactor favors the conversion of the inlet gas pressure to a high temperature within the reactor by kinetic dissipation. This is a result of the planar geometry of the reactor. Consequently the plasma reaction efficiency as well as thermal efficiency is significantly improved.

In a second aspect, the invention relates to a multistage plasma reactor according to claim 12.

In a third aspect, the invention relates to the use of a plasma reactor according to claim 13. In a preferred embodiment of the second aspect, the invention relates to the use of a plasma reactor according to claim 14 for hybrid plasmalysis of methane to hydrogen.

Conversion of methane to hydrogen is currently done industrially through steam reforming, forming a mixture of hydrogen, CO and CO₂. Hybrid plasmalysis of methane to hydrogen and carbon black advantageously allows for easy separation between hydrogen and carbon black. No CO or CO₂ is produced and more hydrogen is produced per unit of methane. This is ecologically desirable to reduce greenhouse gas emissions. Additionally, the amount of thermal energy (defined by standard reaction enthalpy) required to dissociate CH₄ in H₂ and C is considerably lower per unit of H₂ than steam reforming methane as well as electrolysis of water.

A high temperature is required to obtain a desirable reaction equilibrium (shifted towards the dissociated products); but the dissociation reaction itself absorbs a rather small amount of energy from the environment compared to steam reforming or dissociation of water (e.g. electrolysis).

### DESCRIPTION OF FIGURES

The following numbering refers to:
1 High pressure gas source
2 Axial gas inlet
3 Radial injection slits
4 Upstream gas expansion disc (optional)
5 Illustration of possible gas expansion within the reactor space
6 Downstream gas expansion disc
7 Cylindrical reactor container
8 Wave source
9 Waveguide and impedance matching device suitable to adjust and direct waves.
10 Inner core of the upstream gas expansion disc (electrode)
11 External cladding or coating of the upstream gas expansion disc (dielectric)
12 Inner core of the downstream gas expansion disc (electrode)
13 External cladding or coating of the downstream gas expansion disc (dielectric)
14 Illustration of the gliding arc hybrid plasma
15.I and 15.II is the pair of electrodes between which the gliding arc hybrid plasma is generated.
16 Heat exchanger
17 Liquid refrigerant
18 Refrigerant vapour
19 Evanescent point source

FIG. 1 shows a cross-sectional side view and cross-sectional top view of an embodiment of a plasma reactor according to the present invention.

FIG. 2 shows a cross-sectional side view of an embodiment of a single and multistage plasma reactor according to the present invention.

FIG. 3 shows a cross-sectional side view of an embodiment of a plasma reactor with wave plasma generation.

FIG. 4A shows a cross-sectional side view of an embodiment of a plasma reactor with dielectric barrier discharge (DBD) plasma generation.

FIG. 4B shows a cross-sectional top view of an embodiment of a plasma reactor with dielectric barrier discharge (DBD) plasma generation.

FIG. 4C shows a cross-sectional side view of a downstream gas expansion disc and upstream gas expansion disc suitable for dielectric barrier discharge (DBD) plasma generation.

FIG. 5A shows a cross-sectional top view of an embodiment of a plasma reactor with gliding arc plasma generation means.

FIG. 55 shows a cross-sectional top view of an embodiment of a plasma reactor with gliding arc plasma generation means during operation.

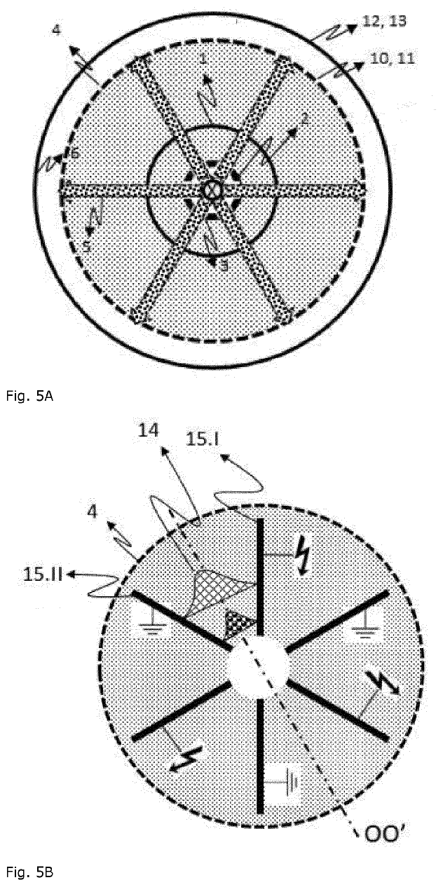

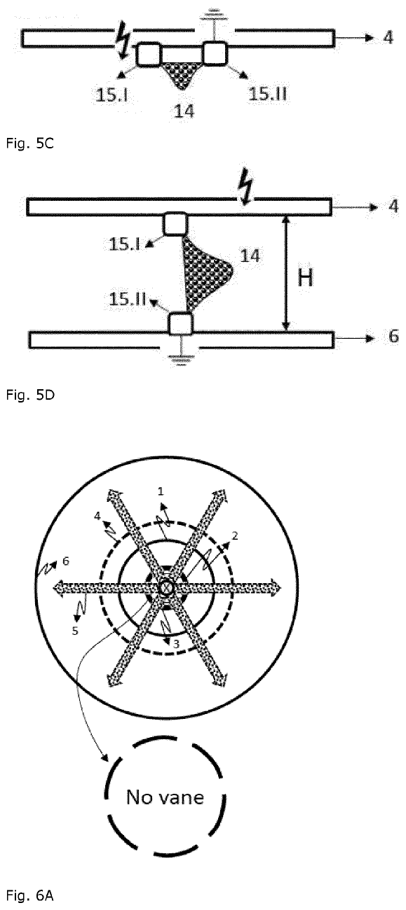

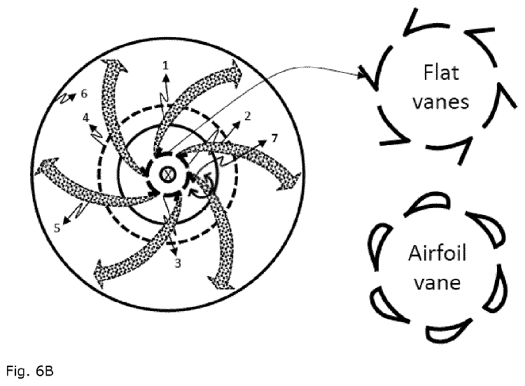

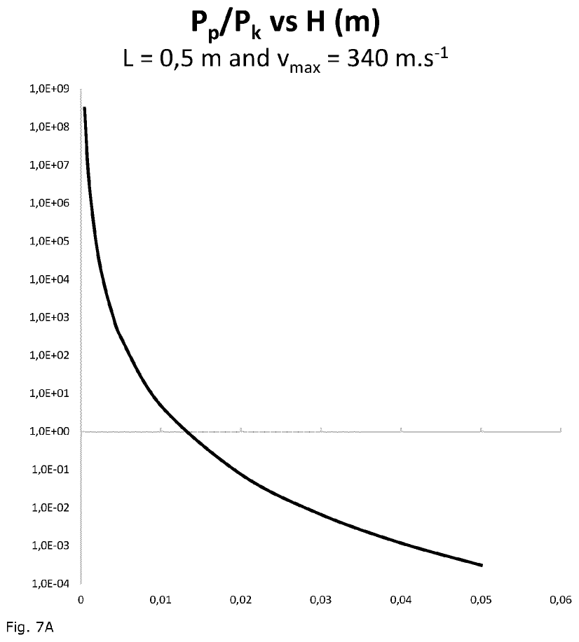

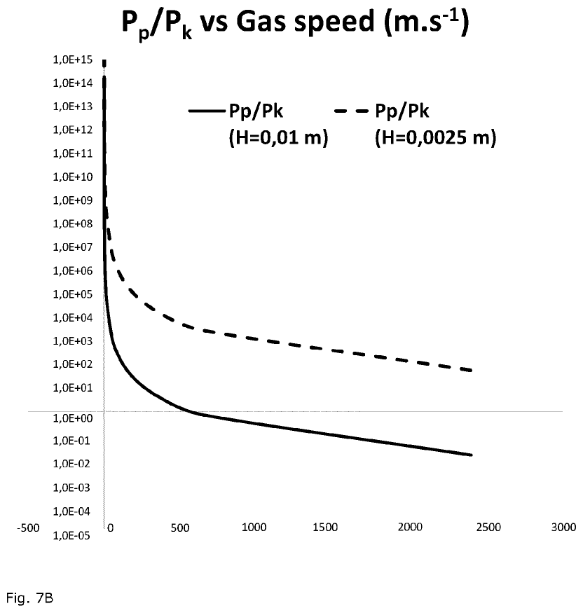

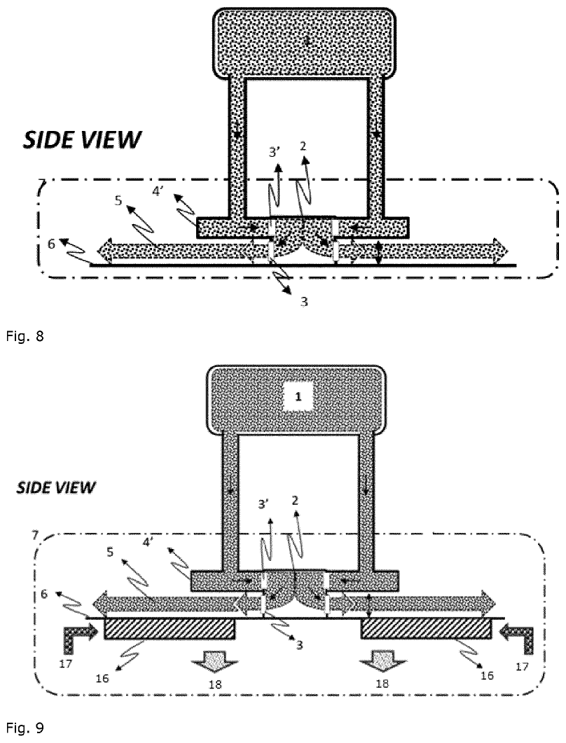

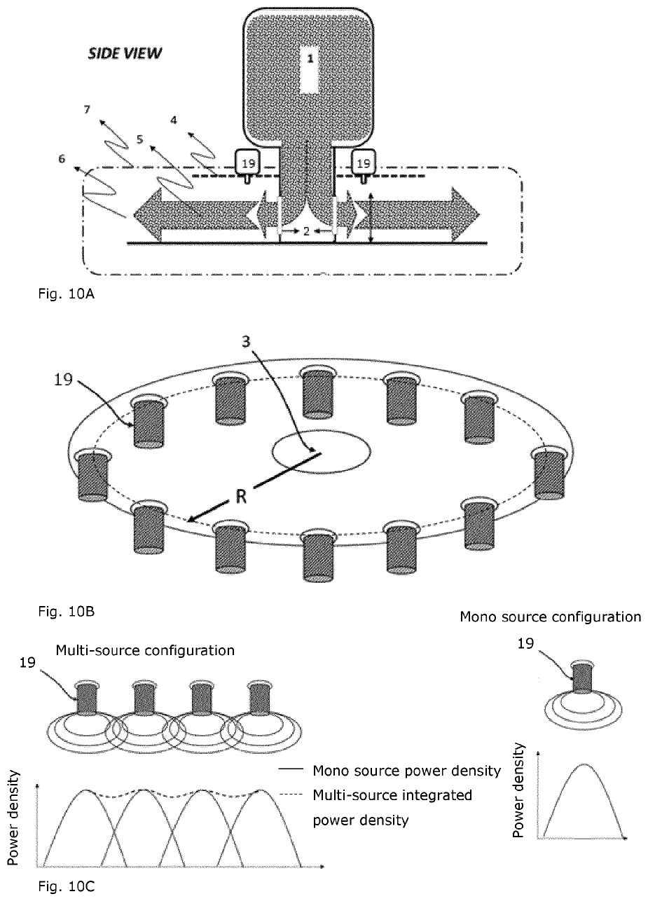

FIG. 5C shows a cross-sectional side view of a downstream gas expansion disc suitable for gliding arc plasma generation.

FIG. 5D shows a cross-sectional side view of an alternative downstream gas expansion disc and upstream gas expansion disc suitable for gliding arc plasma generation.

FIG. 6A shows a cross-sectional top view of an embodiment of a plasma reactor without vanes.

FIG. 65 shows a cross-sectional top view of an embodiment of a plasma reactor with vanes.

FIG. 7A shows a graph representing the ratio of dissipative forces to inertial forces of the expanding gas in the reactor space in function of the width H between an upstream expansion disc and a downstream expansion disc (m).

FIG. 75 shows a graph representing the ratio of dissipative forces to inertial forces of the expanding gas in the reactor space in function of the gas velocity (m/s).

FIG. 8 shows a cross-sectional side view an embodiment of a plasma reactor wherein the upstream expansion disc is a hollow cylinder according to the present invention.

FIG. 9 shows a cross-sectional side view an embodiment of a plasma reactor wherein the upstream expansion disc is a hollow cylinder and the downstream expansion disc is provided with a planar heat exchanger according to the present invention.

FIG. 10A shows a schematic cross-sectional side view of an embodiment of a plasma reactor with multiple point source microwave sources (12).

FIG. 105 shows a schematic perspective of an embodiment of a plasma reactor with multiple point source microwave sources (12).

FIG. 10C shows a schematic representation of the power density for mono source and multi-source microwave plasma generation.

### DETAILED DESCRIPTION OF THE INVENTION

The present invention concerns a reactor suitable for chemical reactions as well as creating a plasma within at least a part of the reactor.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:

“A”, “an”, and “the” as used herein refers to both singular and plural referents unless the context clearly dictates otherwise. By way of example, “a compartment” refers to one or more than one compartment.

“Comprise”, “comprising”, and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, element, members, steps, known in the art or disclosed therein.

Furthermore, the terms first, second, third and the like in the description and in the claims, are used for distinguishing between similar elements and not necessarily for describing a sequential or chronological order, unless specified. It is to be understood that the terms so used are interchangeable under appropriate circumstances and that the embodiments of the invention described herein are capable of operation in other sequences than described or illustrated herein.

The recitation of numerical ranges by endpoints includes all numbers and fractions subsumed within that range, as well as the recited endpoints.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6 or ≥7 etc. of said members, and up to all said members.

A “thermal plasma” as used herein refers to a plasma in which the electron temperature, ion temperature and gas temperature is about equal. Preferably the absolute temperature of electrons Tₑ, ions Tᵢ and gas T_{g} deviates at most 20%, more preferably the absolute temperature between ions Tᵢ and electrons Tₑ deviates at most 15%, more preferably the absolute temperature between ions and electrons deviates at most 10%, more preferably the absolute temperature between ions and electrons deviates at most 5%, most preferably the absolute temperature between ions and electrons deviates at most 1%.

A “non-thermal” or “cold plasma” as used herein refers to a plasma which is not in thermodynamic equilibrium, because the electron temperature Tₑ is much hotter than the temperature of heavy species (ions and neutrals). The temperature of the electrons Tₑ is much higher than the temperature of the ions Tᵢ and the gas.

A “hybrid plasma” as used herein refers to is a superposition of a thermal and a non-thermal plasma. Preferably, a hybrid plasma has zones which form a thermal plasma, that is to say zones in which ions and electrons are in thermodynamic equilibrium and zones which form a non-thermal plasma, that is to say electrons are at a substantially higher temperature than ions and neutrals.

“Hybrid plasmalysis” as used herein refers to the decomposition of substances under the influence of a hybrid plasma. It further includes the possible recombination of ionized species to end products which are generally not ionized.

Unless otherwise defined, all terms used in disclosing the invention, including technical and scientific terms, have the meaning as commonly understood by one of ordinary skill in the art to which this invention belongs. By means of further guidance, definitions for the terms used in the description are included to better appreciate the teaching of the present invention. The terms or definitions used herein are provided solely to aid in the understanding of the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In a first aspect, the invention relates to a plasma reactor comprising
a reactor space,
an axial gas inlet suitable for fluid flow in an axial direction, said axial inlet comprising radial injection slits for discharging a jet of gaseous mixture into said reactor space,
a downstream gas expansion disc, which extends radially from the coaxial inlet and is located downstream of said radial injection slits with respect to said axial direction,
plasma generating means suitable for ionizing a gaseous medium within said reactor space, and
a cylindrical reactor container, coaxial with said gas inlet, encompassing said reactor space, said reactor container comprising outlet means.

In a preferred embodiment of the invention, said plasma reactor further comprises an upstream gas expansion disc, which extends radially from the coaxial inlet and is located upstream of said radial injection slits with respect to said axial direction.

In a further preferred embodiment of the invention, the width H between the downstream gas expansion disc and the upstream gas expansion disc is lower than 100 cm, more preferably lower than 75 cm, more preferably lower than 50 cm, more preferably lower than 25.00 cm, more preferably lower than 20.00 cm, more preferably lower than 10.00 cm, more preferably lower than 8.00 cm, more preferably lower than 6.00 cm, more preferably lower than 5.00 cm, more preferably lower than 4.00 cm, more preferably lower than 3.00 cm, more preferably lower than 2.00 cm, more preferably lower than 1.00 cm, more preferably lower than 0.80 cm, more preferably lower than 0.60 cm, more preferably lower than 0.50 cm, more preferably lower than 0.40 cm, more preferably lower than 0.30 cm, more preferably lower than 0.25 cm, more preferably lower than 0.20 cm.

In a preferred embodiment of the invention, said upstream gas expansion disc is provided with heat-exchanging means. In another preferred embodiment of the invention, said downstream gas expansion disc is provided with heat-exchanging means. In a more preferred embodiment, both the upstream gas expansion disc and the downstream gas expansion disc are provided with heat-exchanging means. Heat exchanging means are known in the art. In a preferred embodiment, the gas expansion discs are provided with hollow fluid passages. These fluid passages may be used to heat a fluid, such as water. Cooling is advantageous as thermal management of the reactor space helps maintain its durability and reduce production costs. Additionally, heat recovery improves the thermal efficiency of the plasma reactor and reduces its operating costs.

In a preferred embodiment of the invention, the upstream injection disc is a hollow cylinder. More preferably, said hollow cylinder is provided with a tangential preheat gas inlet. The hollow cylinder is further provided with an axial preheat gas outlet, which is in fluid communication with the axial gas inlet of the first embodiment of the invention. This preferred embodiment is shown in FIG. 8. Pressurized reactant gas (1) is tangentially supplied to the outer part of the hollow cylinder which doubles as upstream gas expansion disc (4), where it forms a vortex and preheats through heat-exchange effects with the plasma reactor. From the hollow cylinder, pre-heated gas flows radially towards the center through a first set of radial slits (3′) into the axial gas inlet. From the axial gas inlet, the pre-heated gas flows in a radial direction through the radial injection slits (3) into the reactor space. In a further preferred embodiment, the hollow cylinder is provided with vanes suitable to initiate or improve vortex flow and/or promote turbulence and/or improve heat exchange. This setup allows the reactant gas to be preheated before it is supplied to the axial gas inlet and injected radially into the reactor space. More preferably, the gas reactant may be preheated by supplying high pressure gas into said hollow cylinder, whereby friction effects and vortices initiate a global vortex flow and convert pressure to heat. Additional heat is provided through heat-exchange effects with the plasma reactor. When multiple gas streams are utilized, this also improves mixing of the gas flows. This design advantageously provides thermal self-regulation, reducing difficulty of operation and improving safety of the plasma reactor.

In a more preferred embodiment, the downstream gas expansion disc and the upstream gas expansion disc are adapted to thermal plasma (dissociation) zones and high heat-exchange (quenching, recombination, condensation) zones. Preferably, the thermal plasma zones are suitable for limited heat-exchange; including materials and/or coatings with limited thermal conductivity. Preferably, the high heat-exchange zones are suitable for high heat-exchange. Particularly materials suitable for thermal conductivity; but also heat-exchanging means. Preferably the thermal plasma zone is radially closer to the axial gas inlet than the high heat-exchange zone.

In a preferred embodiment, the operation of these high heat-exchange zones is switchable, that is to say the operation between quenching and slower cooling can be switched as required. Advantageously this allows fine-tuning of the selectivity of the recombination reactions. In a particular embodiment, the high heat-exchange zones may be swapped between (slow) cooling and quenching modes. This can for example allow to produce either solid forms of carbon (amorphous carbon black or crystallized forms (such as graphene or graphite)) with a controlled cooling operation (slow cooling faster—e.g. via gas-liquid exchangers) or, on the contrary, non-solid carbonaceous forms such as C2-C5 type hydrocarbons (for example acetylene) in quenching operation (very quick cooling rate via a gas-cooling vapor exchanger) from a hydrocarbon (preferably methane) feedstock.

A switchable operation mode for tuning reaction selectivity can be achieved in various methods. In particular, the upward and/or downward expansion disc can serve as heat exchanger. FIG. 9 shows a preferred reactor design in which the downward expansion disc is provided with a planar heat exchanger. Planar heat exchanger (16) is provided with a refrigerant, preferably an evaporable cold liquid (17), more preferably water. The liquid refrigerant (17) evaporates on the planar heat exchanger (16), and the generated vapor (18) is regenerated for reuse of the heat. Such a planar heat exchanger can be operated in evaporative mode with fine refrigerant droplet to achieve very efficient quenching. The planar heat exchanger can be operated in liquid/liquid or evaporative mode at lower flow rates to achieve slow cooling. Preferably, the planar heat exchanger is operated in liquid/liquid. Furthermore, the flow and temperature of the refrigerant can be adapted to switch between quenching and slow cooling modes. In a preferred embodiment, the thermal energy captured by the refrigerant is utilized. For example, the heat may be used directly, it may be utilized as heat-exchange or to produce electricity or could be used downstream to preheat an additional catalytic reactor chamber.

Another embodiment suitable for switchable operation utilizes adiabatic cooling. The present reactor space expands as the plasma travels radially through the reactor, resulting in divergent gas streams. Consequently, adiabatic cooling is achieved.

In another embodiment suitable for switchable operation, additional fluids (in the case of liquids preferably aerosols) may be injected into the reactor space, particularly into the plasma zone or between the plasma zone and the recombination zone. It is clear that injection of fluids or aerosols is not restricted to quenching, but may also be utilized to obtain other desirable effects, such as dissociation of aerosols and form reactive species or just gases such as hydrogen or nitrogen in plasma post-discharge. This may additionally increase the power of the generated plasma. Alternatively, reactor inerting can be achieved with for example argon or nitrogen gas. This is beneficial to improve reactor safety when solid compounds explosive in air are produced and transported in downstream processes.

In a preferred embodiment of the invention, the radial injection slits are provided with radially extending vanes. In a preferred embodiment of the present invention, the vanes are fixed vanes. That is to say the vanes do not rotate, adjust or move during operation of the plasma reactor. Various types of vanes are known within the art and suitable for use within the context of the present invention, including but not limited to: linear vanes, airfoil vanes, detached vanes. The purpose of said vanes is to direct the expanding airflow in a desired direction through the Young-Coanda effect. In particular vanes are suitable to produce a vortex expansion within the cylindrical reactor space. This is be beneficial to improve gas-plasma mixing, in particular micromixing and increase the residence time or the contact-time of gases in the plasma zone within the reactor space for improving physico-chemical conversion efficiency.

The plasma generating means as described herein is preferably chosen from the list of: a wave source, a dielectric barrier discharge, a gliding arc or a combination of thereof. Each of these embodiments will be discussed in more detail.

In a particular embodiment, the invention relates to a plasma reactor according to the first aspect of the invention, wherein the plasma generating means is a wave source. A plasma can be formed from one or more process gases or from a gas mixture by applying an electric field from a power supply, thereby heating the mixture. Suitable wave sources include mid-frequency waves, radio frequency (RF) waves or microwaves; and may be inductively or capacitively coupled. These techniques are known in the art. The plasma reactor according to the present invention can be used with wave sources in both pulsed-mode and continuous mode. In a preferred embodiment, the plasma generating means is a microwave source. In a preferred embodiment, the plasma generating means is a wave source with a waveguide and impedance matching device. In a more preferred embodiment, multiple wave sources and waveguide and impedance matching devices used. Preferably these multiple waveguide and impedance matching devices are set up radially with respect to the reactor. Microwaves are a powerful point source. The waveguide and impedance matching box may be used to inject power where needed without requiring electrodes within the reactor. Constructive interference can be utilized to obtain zones of plasma with high molecular dissociation. Destructive interference can be utilized to reduce the power density in other areas.

The waves created by the wave source are preferably plane waves. The waves created by the wave source are more preferably stationary waves. Stationary waves are well suited for creating zones of maximum and minimum power density due to interference. This is especially true when multiple wave sources are used. Stationary waves are easier to control with respect to interference; especially when taking into account forward injection/backward reflection. This is beneficial to generate zones of high dissociation and zones that allow efficient recombination; thus improving the energy efficiency of the reactor.

In a particular embodiment of the first aspect, the invention relates to a plasma reactor comprising
a reactor space,
an axial gas inlet suitable for fluid flow in an axial direction, said axial inlet comprising radial injection slits for discharging a jet of gaseous mixture into said reactor space,
a downstream gas expansion disc, which extends radially from the coaxial inlet and is located downstream of said radial injection slits with respect to said axial direction,
a cylindrical reactor container, coaxial with said gas inlet, encompassing said reactor space, said reactor container comprising outlet means,
at least one wave source and
at least one waveguide and impedance matching box configured to create plane waves at least partially within the reactor space.

In another particular embodiment, the invention relates to a plasma reactor according to the first aspect of the invention, wherein the plasma generating means is a dielectric barrier discharge (DBD). In a preferred embodiment, the plasma reactor comprises both an upstream gas expansion disc and a downstream gas expansion disc having an electrically conductive inner core or electrode and an external dielectric coating, suitable to generate a DBD plasma. The DBD plasma is generated by connecting a first electrode to a high voltage generator (AC and pulsed-DC modes) and grounding the second electrode. Suitable materials for the electrodes may be chosen from but not limited to stainless steel, refractive metallic alloys and conductive carbides. Suitable materials for a dielectric coating may be chosen from but not limited to Al₂O₃, SiO₂ and ZrO₂. Advantageously, the power is distributed homogeneously between the electrodes. This leads to a large overlap with the expanding gas between said electrodes. Furthermore it allows to designate a first zone with cold plasma, suitable for reactant dissociation and a second zone without plasma, suitable for condensation and recombination. These zones are tightly controlled by the geometry of the upstream and downstream gas expansion discs. Additionally, the overlap between the power distribution and expanding gas is large due to the reactor design.

In a particular embodiment of the first aspect, the invention relates to a plasma reactor comprising
a reactor space,
an axial gas inlet suitable for fluid flow in an axial direction, said axial inlet comprising radial injection slits for discharging a jet of gaseous mixture into said reactor space,
a downstream gas expansion disc, which extends radially from the coaxial inlet and is located downstream of said radial injection slits with respect to said axial direction,
an upstream gas expansion disc, which extends radially from the coaxial inlet and is located upstream of said radial injection slits with respect to said axial direction, wherein the upstream gas expansion disc and the downstream gas expansion disc comprise a conductive inner core and an external dielectric coating, and
a cylindrical reactor container, coaxial with said gas inlet, encompassing said reactor space, said reactor container comprising outlet means.

In another particular embodiment, the invention relates to a plasma reactor according to the first aspect of the invention, wherein the plasma generating means is gliding arc plasma generation. Gliding arc hybrid plasma is generated between a pair of electrodes. Preferably multiple pairs of electrodes (i.e. an even number of electrodes) is used. In a preferred embodiment, these electrodes are provided on a downstream gas expansion disc or an upstream gas expansion disc. In one embodiment, the electrode pairs may be provided on a downstream gas expansion disc. In another embodiment, the electrode pairs may be provided on an upstream gas expansion disc. In another embodiment, the first electrode of the electrode pairs may be provided on an upstream gas expansion disc and the second electrode of the electrode pairs may be provided on the downstream gas expansion disc. Preferably, the electrodes are wire-shaped and radially oriented. More preferably the electrodes have a diameter of 0.05 mm to 2.00 mm, more preferably 0.10 mm to 1.00 mm. The number of electrode pairs, their geometry (localization in the reactor, length, . . . ) the electrical power (voltage and current) determines the power density within the expanding gas. The electrodes are made of temperature resistant and conductive materials. Such materials may be chosen from but are not limited to stainless steel, high melting temperature metal alloys, conductive and ceramics (ie carbon). Management of electrical power distribution and voltage/current ratio is essential.

This can be achieved by connecting electrodes pairs in parallel (high current divided between all electrodes pairs) and series (unique current and voltage drops at each electrode pair).

Gliding arc reactors can operate with various voltage sources, including but not limited to DC, pulsed-DC, single phase AC, tri-phase, multi-phased currents. The currents may be pulsed, for example pulsed-DC to increase peak-power, with a high-frequency preferably matching the arc impedance.

In another particular embodiment of the first aspect, the invention relates to a plasma reactor comprising
a reactor space,
an axial gas inlet suitable for fluid flow in an axial direction, said axial inlet comprising radial injection slits for discharging a jet of gaseous mixture into said reactor space,
a downstream gas expansion disc, which extends radially from the coaxial inlet and is located downstream of said radial injection slits with respect to said axial direction, wherein at least one electrode pair has been deposited on said downstream gas expansion disc, and
a cylindrical reactor container, coaxial with said gas inlet, encompassing said reactor space, said reactor container comprising outlet means.

In another particular embodiment of the first aspect, the invention relates to a plasma reactor comprising
a reactor space,
an axial gas inlet suitable for fluid flow in an axial direction, said axial inlet comprising radial injection slits for discharging a jet of gaseous mixture into said reactor space,
at least one electrode pair comprising a first and a second electrode,
a downstream gas expansion disc, which extends radially from the coaxial inlet and is located downstream of said radial injection slits with respect to said axial direction, wherein the first electrode is deposited on said downstream gas expansion disc,
an upstream gas expansion disc, which extends radially from the coaxial inlet and is located upstream of said radial injection slits with respect to said axial direction, wherein the second electrode is deposited on said upstream gas expansion disc, and
a cylindrical reactor container, coaxial with said gas inlet, encompassing said reactor space, said reactor container comprising outlet means.

In a second aspect, the present invention relates to a multistage plasma reactor comprising at least one plasma reactor cell according to the first aspect of the invention. Preferably, the multistage plasma reactor comprises a stack of plasma reactors according to the first aspect of the invention. In a preferred embodiment, said multistage plasma reactor utilizes a single common gas inlet. The planar reactor according to the present invention can advantageously be stacked around a single common gas inlet. This allows for convenient and easy upscaling. The upscaling can furthermore be utilized in a modular manner if this is desired. Furthermore, the multistage plasma reactor as a whole doesn't have the planar shape of a single stage and can be designed to better fit an available space or design constraints; while retaining the benefits of improved thermal and plasma reaction efficiency associated with the planar shape of a single stage.

In a third aspect, the present invention relates to the use of a plasma reactor according to the first aspect of the invention or a multistage reactor according to the second aspect of the present invention.

In a preferred embodiment of the third aspect, the plasma reactor is used thermal gas dissociation reactions. Suitable examples include but are not limited to thermal dissociation of hydrocarbons, H₂S, H₂Se and so forth.

In another preferred embodiment of the third aspect, the plasma reactor is used for gas chemical reactions. In a more preferred embodiment, the reaction may be used to allow Sabatier-type reactions in the absence of a catalyst; that is to say reforming CO₂ and hydrogen to hydrocarbons and/or reforming nitrogen gas and hydrogen gas to ammonia.

In a preferred embodiment, the present invention relates to the use of a plasma reactor according to the first aspect of the invention or a multistage reactor according to the second aspect of the present invention for hybrid plasmalysis of hydrocarbons, preferably methane, to hydrogen and carbon black. Pyrolytic plasma decomposition of hydrocarbons, such as methane, into carbon black and hydrogen is known. However, many issues with this technology remain. Consequently, grey hydrogen on an industrial scale is generally produced with significant CO2 as a byproduct by steam reforming of hydrocarbons rather than hybrid plasmalysis of hydrocarbons. In particular the plasma reactors known in the art require low hydrocarbon inlet pressures as and provide hydrogen at a low outlet pressure, neither of which are suitable for industrial application. Furthermore, the thermal efficiency of the reactors is generally low. Generally the efficiency is low because the conditions suitable for decomposition of hydrocarbons and formation of hydrogen and carbon black only occur in a small segment of the reactor space. The plasma reactor of the present invention overcomes or ameliorates several of these issues. However, it is obvious that the invention is not limited to this application.

The reactor according to the invention can be used in all sorts of high temperature reactions, particularly plasma reactions and gas reactions. Gas reactions as well as “reactant gas” as described herein refers includes homogeneous gas mixtures as well as dispersions in which the continuous medium is a gas. In particular, liquid-gas dispersions (aerosols) and solid-gas dispersions (solid aerosols) can also be employed within the present invention, both as reactant gas as well as formed intermediate at any stage in the reactor. Such intermediates may be formed due to the chemical and plasma reactions that occur within the plasma reactor, but may also be formed by intentionally dispersing solids or liquids at any point in the reactor space. The invention is further described by the following non-limiting examples which further illustrate the invention, and are not intended to, nor should they be interpreted to, limit the scope of the invention.

The present invention will be now described in more details, referring to examples that are not limitative.

### Examples and/or Description of Figures

With as a goal illustrating better the properties of the invention the following presents, as an example and limiting in no way other potential applications, a description of a number of preferred applications of the method for examining the state of the grout used in a mechanical connection based on the invention, wherein:

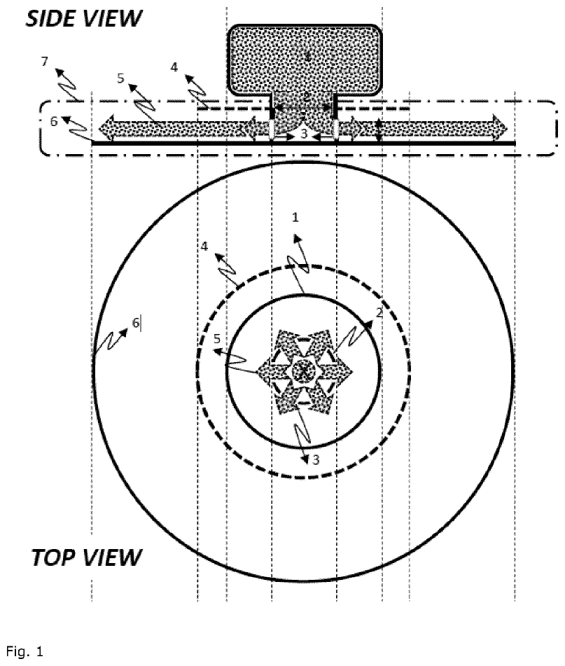

A cross-sectional side view and cross-sectional top view of an embodiment of a plasma reactor is shown in FIG. 1. High pressure tank 1 supplies the axial gas inlet 2 with gaseous or vaporized reactants. The pressure in the axial gas inlet may be up to 20-50 bar. This is advantageous as higher pressures allow for higher gas throughput. Additionally, gasses in industry are commonly stored and transferred at high pressures. It is beneficial to at least utilize the potential energy of the pressurized gas.

The pressurized gas enters the reactor space through the radial injection slits 3. The expanding gas stream 5 expands radially within the reactor space. Downstream gas expansion disc 6 supports the expansion of the gas-film due to the Young-Coanda effect. The diameter of this disc can be adjusted for reaching a desired pressure and radial velocity of the expanding gas. It can also be utilized to fine-tune the plasma power distribution within the reactor. The optional upstream gas expansion disc also aids in shaping the gas expansion stream and adjusting the gas pressure and radial velocity. The gas properties can further be adjusted by variation of the diameter of the upstream gas expansion disc as well as the width H between the upstream and downstream gas expansion discs. The reactor space is enclosed by a reactor chamber external box 7, provided with gas outlet means (not drawn).

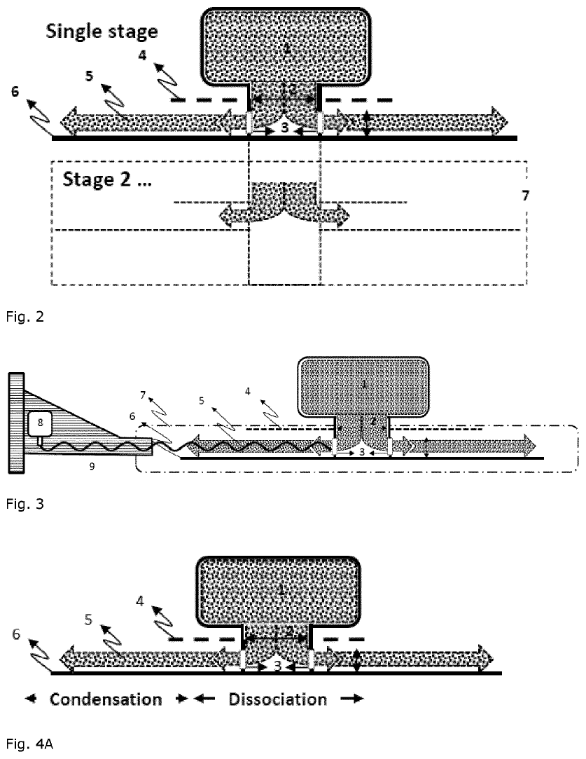

FIG. 2 shows an illustration of a cross-sectional side view of an embodiment of a single and multistage plasma reactor according to the present invention. Several stages of plasma reactor can be stacked around an extended axial gas inlet.

FIG. 3 shows an embodiment of a plasma reactor with wave plasma generation. A wave source or magnetron 8 is used to generate waves. These waves are guided and adjusted with a waveguide and impedance matching box 9. Multiple magnetrons and waveguide and impedance boxes can be utilized, preferably in a radial arrangement, to obtain high power transfers through waves towards the extending gas. Additionally, the waveguide and impedance matching box can be configured for zones of constructive interference to obtain areas within the reactor space with high power input.

In a further preferred embodiment, the plasma is generated by a series of multiple wave sources, particularly evanescent point sources (19). FIGS. 10A, 10B and 10C show a schematic representation of such a preferred embodiment. This allows for an increase of plasma power density close to the upstream region of the reactor by using an evanescent point source. Distance between the multiple wave sources adjusts the power density. Preferably, a toroidal plasma with relatively uniform energy density is created. In particular, the use of antennas allowing the generation of plasma maintained by microwaves allows the creation of a toroidal plasma zone can be created around the gas injection point. These high-density sources provide high concentrations of reactive species and electrons. These species are the energetic vectors of the plasma that allow the dissociation of molecules, which always takes place via collisional processes involving electrons. In general, the production of excited species is more efficient in the continuous case than in the high frequency case when the electron density is constant. However, if one wants to evaluate the efficiency of the different plasmas from a practical point of view, it is important to consider the production of species at constant absorbed power density. Modelling of the density of excited states as a function of the excitation energy for a constant power density show that the continuous case is never the most favorable but that it is preferable to work at higher frequencies. On the other hand, dissociation reactions have maximum cross sections for low energy electrons.

If we consider the influence of the excitation frequency of the electric field on the densities and energy distributions within the plasma, it appears that when the frequency increases, the electron density increases and the average energy of the electrons decreases. The choice of microwave frequency is therefore well justified here in the use of this type of plasma for the dissociation of hydrocarbon molecules. Although microwave plasma sources are well known for their performances in terms of creating high densities of reactive species, they have often been considered difficult to obtain in industrial systems where large plasma volumes are required. In consequence, to create a large volume of plasma it is important to overcome the critical density which limits the propagation of the waves. The critical density is the density of charged species in a plasma above which the wave is reflected. This limits the long-range propagation of the exciting wave and therefore limits the propagation of the plasma itself. The plasma causes a self-screening effect. To overcome this limitation, it is necessary to distribute the plasma sources in a smart way to generate a uniform plasma annular zone with high energy content.

A schematic of a preferred embodiment is shown in FIG. 10B. In this embodiment, the antennas (12) are arranged around the circumference of a circle to create a plasma torus which allows the gas leaving the nozzle (3) to be treated uniformly with a high-density microwave plasma to maximise conversion.

As shown schematically in FIG. 10C, by arranging the antennas at an equal but well-chosen inter-distance, it is possible thus to generate a powerful plasma of axial symmetry located at a distance R from the centre of the reactor. The optimum distance will create a uniform resultant power density along the axis by overlapping the evanescent waves from each antenna. This will allow the creation of the uniform plasma torus distributed over the circle joining the antenna centres.

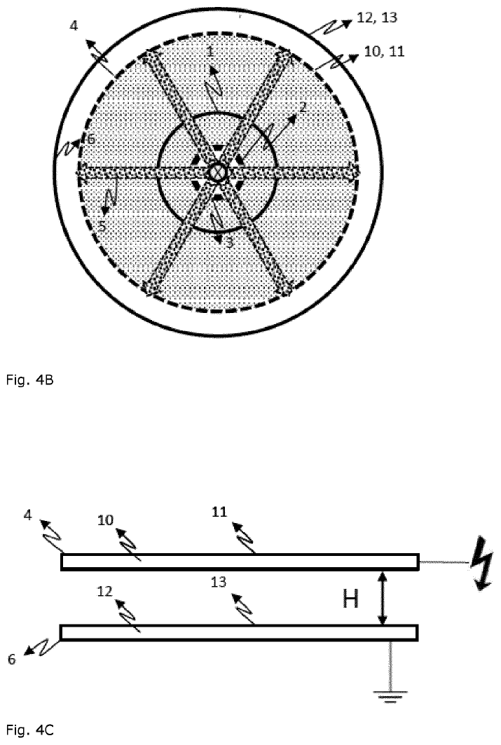

FIGS. 4A, 4B and 4C illustrate an embodiment of a plasma reactor with dielectric barrier discharge (DBD) plasma generation. DBD requires two electrodes coated with dielectric material. In a preferred embodiment, the electrodes are the upstream and downstream gas expansion discs such as illustrated in FIG. 4C. The core of the upstream gas expansion disc 10 and downstream gas expansion disc 12 is made of a conductive material such as stainless steel, refractive metallic alloys, conductive carbides and conductive metal oxides. The external surface of the upstream gas expansion disc and the downstream gas expansion disc are cladded or coated with dielectric material such as Al₂O₃, SiO₂ or ZrO₂. By applying a high voltage generator to one electrode 10 or 12 and grounding the other electrode, a dielectric barrier discharge is created. This setup is advantageous as the plasma power is generated homogeneously inside the interspace between the downward and upward gas expansion discs. Additionally there is perfect overlap with the expanding gas layer. By limiting the length of the gas expansion discs or the electrode cores within the gas expansion discs, a first well-controlled plasma dissociation zone can be created in the reactor space followed by a second condensation and recombination zone. For example, methane can be dissociated into atomic hydrogen, carbon and their ions in the dissociation zone and consequently condensed to form hydrogen gas H₂ and carbon nanopowders in the condensation zone.

FIGS. 5A and 5B illustrate an embodiment of a plasma reactor with gliding arc plasma generation means. Gliding arc hybrid plasma is generated between a pair of electrodes 15.I and 15.II. An electric arc can be ignited inside the gas layer in the reactor space, preferably near the gas injection slits. This creates a thermal plasma zone that favors strong dissociation of the reactant gas (dissociation zone). As the gas expands radially, the power density decreases creating zones with colder plasma and/or no plasma allowing the condensation process.

The downstream gas expansion disc and the optional upstream gas expansion disc can advantageously be used to hold the electrodes 15.I and 15.II. FIG. 5C illustrates an embodiment of gliding arc plasma generating means wherein both electrodes 15.I and 15.II are positioned on an upstream gas expansion disc 4. In another embodiment, both electrodes 15.I and 15.II can be positioned on the downstream gas expansion disc 6. FIG. 5D illustrates an embodiment of gliding arc plasma generating means wherein a first electrode 15.I is positioned on the upstream gas expansion disc 4 and a second electrode 15.II is positioned on the downstream gas expansion disc. The electrodes are made of a conductive material which can withstand high temperatures, such as stainless steel wire, various high melting temperature alloys, electrically-conductive ceramics and so forth. Suitable deposition techniques are known in the art. The electrodes are preferably wire-shaped and positioned in a radial direction. The electrodes preferably have a thickness between 0.05 and 2 mm, more preferably between 0.1 and 1 mm.

A cross-sectional top view of an embodiment of a plasma reactor without vanes is shown in FIG. 6A. a cross-sectional top view of an embodiment of a plasma reactor with vanes is shown in FIG. 6B. Static vanes, preferably attached near the gas injection slits on the side of the reactor space may be used to adjust the injection angle and flow of gaseous reactants into the reactor space through the Young-Coanda effect. In particular, vortexes or turbulence may be created. This can improve the mixing of the gas and plasma within the reactor. A vortex flow has a significantly increased flow path within the reactor, which is associated with a greater reduction in gas velocity within said reactor. This is beneficial to allow the axial gas inlet to operate at higher pressures.

A graph showing the ratio of dissipative forces to inertial forces P_{P}/P_{K} [−] in the reactor space in function of the width H [m] between an upstream expansion disc and a downstream expansion disc is shown in FIG. 7A. It follows that kinetic dissipation is high for low width H. In particular when H is lower than 0.01 cm, kinetic forces are larger than the inertial forces. This graph assumes a maximum gas velocity vₘₐₓ of 340 m/s and a reactor radius L of 0.5 m.

A graph representing the ratio of dissipative forces to inertial forces P_{P}/P_{K} [−] of the expanding gas in the reactor space in function of the gas velocity (m/s) is shown in FIG. 7B. This graph shows the case for the width H [m] between an upstream expansion disc and a downstream expansion disc of 1 cm and 0.25 cm respectively. At sufficiently low gas velocities, a width H of 1 cm is sufficient to high kinetic dissipation. At high gas velocities, high kinetic dissipation with respect to inertial forces can be maintained at a width H of 0.25 cm.

The present invention is in no way limited to the embodiments described in the examples and/or shown in the figures. On the contrary, methods according to the present invention may be realized in many different ways without departing from the scope of the invention.

1. A plasma reactor comprising:
a reactor space,
an axial gas inlet suitable for fluid flow in an axial direction, said axial inlet comprising radial injection slits for discharging a jet of gaseous mixture into said reactor space,
a downstream gas expansion disc, which extends radially from the coaxial inlet and is located downstream of said radial injection slits with respect to said axial direction,
plasma generating means suitable for ionizing a gaseous medium within said reactor space, and
a cylindrical reactor container, coaxial with said gas inlet, encompassing said reactor space, said reactor container comprising outlet means.

2. The plasma reactor according to claim 1, wherein said plasma reactor further comprises an upstream gas expansion disc, which extends radially from the coaxial inlet and is located upstream of said radial injection slits with respect to said axial direction.

3. The plasma reactor according to claim 2, wherein the width H between the downstream gas expansion disc and the upstream gas expansion disc is lower than 10 cm, preferably lower than 5 cm, more preferably lower than 1 cm.

4. The plasma reactor according to claim 1, wherein said plasma reactor further comprises an hollow upstream gas expansion disc, wherein said upstream gas expansion disc is preferably a hollow cylinder, wherein said hollow upstream gas expansion disc is provided with a tangential preheat gas inlet and an axial preheat gas outlet, wherein said axial preheat gas outlet is in fluid communication with the axial gas inlet.

5. The plasma reactor according to claim 1, wherein said downstream gas expansion disc is provided with heat-exchanging means.

6. The plasma reactor according to claim 1, wherein the radial injection slits are provided with radially extending vanes.

7. The plasma reactor according to claim 1, wherein the plasma generating means is chosen from the list of: a wave source, a dielectric barrier discharge (DBD), a gliding arc or a combination thereof.

8. The plasma reactor according to claim 1 further comprising:
at least one wave source and
at least one waveguide and impedance matching box configured to create plane waves at least partially within the reactor space.

9. The plasma reactor according to claim 1 further comprising:
an upstream gas expansion disc, which extends radially from the coaxial inlet and is located upstream of said radial injection slits with respect to said axial direction, wherein the upstream gas expansion disc and the downstream gas expansion disc comprise a conductive inner core and an external dielectric coating.

10. The plasma reactor according to claim 1 further comprising:
wherein at least one electrode pair has been deposited on said downstream gas expansion disc.

11. The plasma reactor according to claim 1 further comprising:
at least one electrode pair comprising a first and a second electrode, a downstream gas expansion disc, which extends radially from the coaxial inlet and is located downstream of said radial injection slits with respect to said axial direction, wherein the first electrode is deposited on said downstream gas expansion disc,
an upstream gas expansion disc, which extends radially from the coaxial inlet and is located upstream of said radial injection slits with respect to said axial direction, wherein the second electrode is deposited on said upstream gas expansion disc.

12. The plasma reactor according to claim 4, wherein said tangential preheat gas inlet and an axial preheat gas outlet are suitable for liquid-liquid cooling mode and evaporative cooling mode; and wherein said heat exchanging means are suitable for switching between liquid-liquid cooling mode and evaporative cooling mode.

13. A multistage plasma reactor comprising a stack of plasma reactors according to claim 1.

14. Use of a plasma reactor or multistage plasma reactor according to claim 1.

15. Use of a plasma reactor or multistage plasma reactor according to claim 1 for hybrid plasmalysis of methane to hydrogen.
